(19) United States
(12) Patent Application Publication
(10) Pub. No.: US 2026/0017940 A1
(43) Pub. Date: Jan. 15, 2026

(54) DEFECT FILTERING FOR MASK INSPECTION

(71) Applicant: Applied Materials Israel Ltd., Rehovot (IL)

(72) Inventors: Sapir SHIMON, Rehovot (IL); Asaf BAHAR, Tel-Aviv (IL); Youri TRETIOUK, Maale Adumim (IL); Alexander CHERESHNYA, Kfar-Saba (IL); Ariel SHKALIM, Even-Shmuel (IL)

(21) Appl. No.: 18/770,409

(22) Filed: Jul. 11, 2024

(51) Int. Cl. G06V 10/94; G06V 10/762; G06V 10/778

(52) U.S. Cl. CPC G06V 10/945; G06V 10/762; G06V 10/7788; G06V 2201/06

(57) ABSTRACT

There is provided a system and method of defect filtering for a mask, comprising: clustering a group of defect candidates into one or more clusters each comprising a set of defect candidates ranked by a machine learning (ML) model according to respective probabilities of being a defect of interest (DOI); and filtering each cluster to identify a subset of DOIs, comprising: presenting the set of defect candidates on a graphical user interface (GUI) to a user according to the ranking; upon receiving an indication from the user regarding at least one defect candidate, retraining the ML model based on the indication; using the retrained ML model to re-rank one or more defect candidates that are not yet reviewed, and presenting the re-ranked defect candidates on the GUI for the user; and repeating the retraining, the using and the presenting, until meeting a criterion.

### TECHNICAL FIELD

The presently disclosed subject matter relates, in general, to the field of mask inspection, and more specifically, to defect filtering with respect to a photomask.

### BACKGROUND

Current demands for high density and performance associated with ultra large-scale integration of fabricated micro-electronic devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Semiconductor devices are often manufactured using photo lithographic masks (also referred to as photomasks, masks, or reticles) in a photolithography process. The photolithography process is one of the principal processes in the manufacture of semiconductor devices, and comprises patterning a wafer's surface in accordance with the circuit design of the semiconductor devices to be produced. Such a circuit design is first patterned on a mask. Given the complexity and miniaturization of modern semiconductor devices, even minor defects on a photomask can lead to significant device failures, thereby increasing manufacturing costs and reducing yield. In addition, the mask is often used in a repeated manner to create many dies on one or more wafers. Thus, any defect on the mask will be repeated multiple times on the wafers and will cause multiple devices to be defective. Hence, in order to obtain operating semiconductor devices, the mask must be defect-free.

Despite advancements in mask fabrication technology, the potential for defects remains. These defects can arise from various sources including contamination, processing errors, and material imperfections. Establishing a production-worthy process requires tight control of the overall lithography process. Within this process, critical dimension (CD) control is a determining factor with respect to device performance and yield.

To ensure the quality of photomasks, rigorous mask inspection processes are employed. Various mask inspection methods have been developed and are available commercially. According to certain conventional techniques of designing and evaluating masks, the mask is created and used to expose therethrough a wafer, and then an inspection is performed to determine whether the features/patterns of the mask have been transferred to the wafer according to the design. Any variations in the final printed features from the intended design may necessitate modifying the design, repairing the mask, creating a new mask, and/or exposing a new wafer.

In this regard, verification of the accuracy and quality of the printed features permits an indirect method of verifying the mask. However, since the final printed pattern on the wafer or die is formed after the printing process, e.g., the resist development, the substrate treatment (such as material etching or deposition), etc., it may be difficult to attribute, discriminate, or isolate errors in the final printed pattern to problems associated with the mask and/or the resist deposition and/or the developing processes. Moreover, inspecting the final printed pattern on the wafer or die tends to offer a limited number of samples usable to detect, determine, and resolve any processing issues. This process may also be labor intensive and presents an extensive inspection and analysis time. Alternatively, a mask can be directly inspected using various mask inspection tools.

### SUMMARY

In accordance with certain aspects of the presently disclosed subject matter, there is provided a computerized system of defect filtering for a mask usable for manufacturing a semiconductor specimen, the system comprising a processing circuitry configured to: obtain a group of defect candidates resulting from inspecting the mask; cluster the group of defect candidates into one or more clusters based on attributes thereof, each given cluster comprising a set of defect candidates ranked by a machine learning (ML) model according to respective probabilities of being a defect of interest (DOI) in the given cluster; and filter each cluster to identify a subset of DOIs from the set of defect candidates thereof, comprising: presenting the set of defect candidates on a graphical user interface (GUI) to a user according to the ranking thereof; upon receiving an indication from the user regarding at least one defect candidate being a DOI or a false alarm (FA), retraining the ML model based on the at least one defect candidate and the indication; using the retrained ML model to re-rank one or more defect candidates that are not yet reviewed in the set, and presenting the re-ranked defect candidates on the GUI for the user to provide further indication; and repeating the retraining, the using of the retrained ML model, and the presenting of the re-ranked defect candidates, until meeting a criterion; wherein the subset of DOIs from each cluster of the one or more clusters constitutes a collection of DOIs detected from the group of defect candidates.

In addition to the above features, the system according to this aspect of the presently disclosed subject matter can comprise one or more of features (i) to (x) listed below, in any desired combination or permutation which is technically possible:
(i). The attributes of the defect candidates can be collected during the inspection of the mask. The attributes comprise, for each defect candidate, a background pattern thereof.
(ii). The clustering, based on at least the background pattern of each defect candidate, can enable to identify, in each of the one or more clusters resulting from the clustering, FAs sharing a common root cause related to a similar background pattern.
(iii). The attributes can further comprise, for each defect candidate, one or more of: location on the mask, density in a surrounding area, shape, size, gray level intensity, the number of similar instances in the group of defect candidates, a defectivity grade, edge positioning displacement, and presence of a blemish pixel.
(iv). The clustering can further comprise, for each cluster, assigning a probability to each defect candidate indicative of respective likelihood of being a DOI, and ranking the set of defect candidates in the cluster based on assigned probabilities thereof.
(v). The set of defect candidates in a given cluster can be presented to the user in one or more batches, where defect candidates with highest ranking are presented in a first batch for prioritized review, so as not to miss defect candidates with high likelihood of being DOIs.
(vi). The user can provide the indication by selecting the at least one defect candidate from a batch of defect candidates that is currently presented on the GUI, and marking the selected at least one defect candidate as a DOI or a FA on the GUI.
(vii). The retraining of the ML model can comprise processing the at least one defect candidate by the ML model to obtain a predicted defectivity thereof, and optimizing the ML model using a loss function based on the predicted defectivity and the indication of the at least one defect candidate received from the user.
(viii). The criterion can comprise at least one of: a confirmation from the user that no more DOIs are present in a given cluster, there is no indication of DOIs in a number of consecutive batches of a given cluster, and the set of defect candidates of a given cluster have all been reviewed.
(ix). The filtering of each cluster can reduce the total number of defect candidates to be reviewed by the user, while obtaining the collection of DOIs with maximized capture rate.
(x). The mask can be an Extreme Ultraviolet (EUV) mask or an Argon Fluoride (ArF) mask.

In accordance with other aspects of the presently disclosed subject matter, there is provided a method of defect filtering for a mask usable for manufacturing a semiconductor specimen, comprising: obtaining a group of defect candidates resulting from inspecting the mask; clustering the group of defect candidates into one or more clusters based on attributes thereof, each given cluster comprising a set of defect candidates ranked by a machine learning (ML) model according to respective probabilities of being a defect of interest (DOI) in the given cluster; and filtering each cluster to identify a subset of DOIs from the set of defect candidates thereof, comprising: presenting the set of defect candidates on a graphical user interface (GUI) to a user according to the ranking thereof; upon receiving an indication from the user regarding at least one defect candidate being a DOI or a false alarm (FA), retraining the ML model based on the at least one defect candidate and the indication; using the retrained ML model to re-rank one or more defect candidates that are not yet reviewed in the set, and presenting the re-ranked defect candidates on the GUI for the user to provide further indication; and repeating the retraining, the using of the retrained ML model, and the presenting of the re-ranked defect candidates, until meeting a criterion; wherein the subset of DOIs from each cluster of the one or more clusters constitutes a collection of DOIs detected from the group of defect candidates.

This aspect of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of defect filtering for a mask usable for manufacturing a semiconductor specimen, comprising: obtaining a group of defect candidates resulting from inspecting the mask; clustering the group of defect candidates into one or more clusters based on attributes thereof, each given cluster comprising a set of defect candidates ranked by a machine learning (ML) model according to respective probabilities of being a defect of interest (DOI) in the given cluster; and filtering each cluster to identify a subset of DOIs from the set of defect candidates thereof, comprising: presenting the set of defect candidates on a graphical user interface (GUI) to a user according to the ranking thereof; upon receiving an indication from the user regarding at least one defect candidate being a DOI or a false alarm (FA), retraining the ML model based on the at least one defect candidate and the indication; using the retrained ML model to re-rank one or more defect candidates that are not yet reviewed in the set, and presenting the re-ranked defect candidates on the GUI for the user to provide further indication; and repeating the retraining, the using the retrained ML model, and the presenting the re-ranked defect candidates, until meeting a criterion; wherein the subset of DOIs from each cluster of the one or more clusters constitutes a collection of DOIs detected from the group of defect candidates.

This aspect of the disclosed subject matter can comprise one or more of features (i) to (x) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a functional block diagram of a mask inspection system in accordance with certain embodiments of the presently disclosed subject matter.

FIG. 2 illustrates a generalized flowchart of defect filtering for mask inspection in accordance with certain embodiments of the presently disclosed subject matter.

FIG. 3 illustrates a generalized flowchart of clustering the group of defect candidates into one or more clusters and ranking within each cluster in accordance with certain embodiments of the presently disclosed subject matter.

FIG. 4 illustrates a generalized flowchart of retraining the ML model in accordance with certain embodiments of the presently disclosed subject matter.

FIG. 5 illustrates a schematic illustration of an actinic inspection tool and a lithographic tool in accordance with certain embodiments of the presently disclosed subject matter.

FIG. 6 illustrates an exemplary GUI presenting defect candidates from a given cluster in accordance with certain embodiments of the presently disclosed subject matter.

FIG. 7 illustrates the same GUI presenting defect candidates from another cluster in accordance with certain embodiments of the presently disclosed subject matter.

### DETAILED DESCRIPTION OF EMBODIMENTS

Mask inspection methods may utilize various imaging and detection techniques to identify potential defects on photomasks. These inspections would generally generate a defect file, comprising a list of all detected defect candidates on the mask. Typically, the number of defect candidates in a defect file can reach several hundreds, depending on the complexity of the mask and the sensitivity of the inspection technology used.

Given the high number of potential defects and the critical nature of each, it is impractical and costly for operators to manually review every defect candidate. Manual review processes are limited by time and labor constraints, making it necessary to prioritize which defects are reviewed. However, this prioritization must be handled with utmost care, as missing a true defect could result in significant downstream impacts on device production and functionality.

In particular, the adoption of extreme ultraviolet (EUV) lithography has introduced new challenges and complexities in the mask manufacturing process. EUV technology, essential for producing smaller, more efficient devices, is inherently more complex and prone to unique defects and phenomena not present in traditional photolithography. This complexity often leads to an increased number of false alarms during mask inspections, complicating the task of identifying true defects.

Currently, there is a significant challenge in filtering the large volume of defect candidates to a manageable number for detailed review without compromising the detection of true defects. The goal is often to maintain a 100% capture rate of true defects, ensuring no defective masks proceed to the wafer fabrication stage. Certain existing methods and systems for post-filtering defect candidates often struggle to balance between efficiency and completeness.

Accordingly, certain embodiments of the presently disclosed subject matter propose a mask inspection system and method for post-filtering the defect candidates detected on a mask, which does not have one or more of the disadvantages described above. The present disclosure proposes to cluster the defect candidates into clusters where each defect candidate is ranked based on its probability of being a DOI, present each cluster of defect candidates on a unique GUI for a user's review, and use active learning on-the-fly based on user's feedback to retrain the model, re-rank the unreviewed candidates, and present them according to the new rankings. The proposed method can filter a large volume of defect candidates to a smaller number meeting a given defect review budget while maximizing detection capture rate, thereby enhancing the efficiency of the photomask fabrication process and the overall yield of semiconductor manufacturing, as will be detailed below.

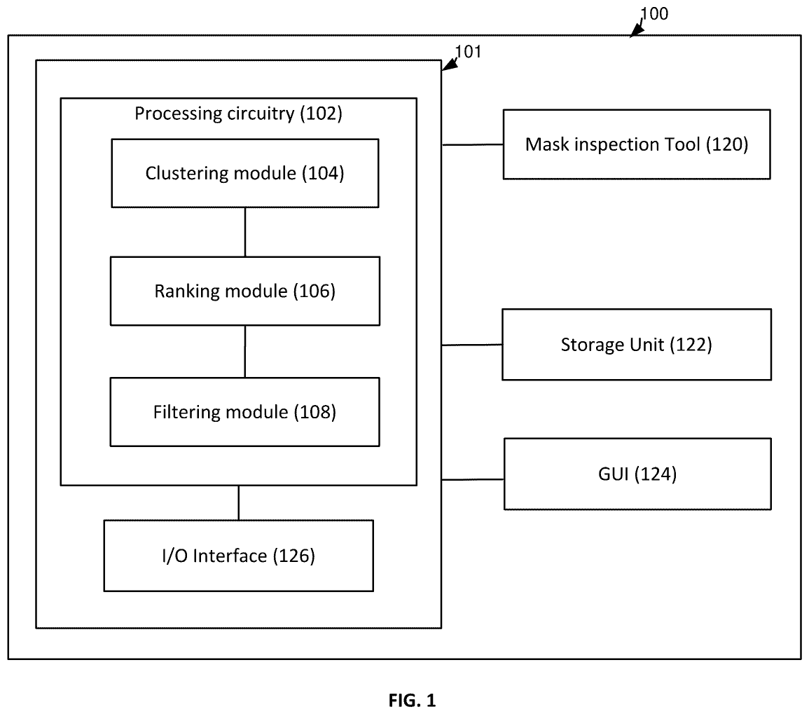

Bearing this in mind, attention is drawn to FIG. 1 illustrating a functional block diagram of a mask inspection system in accordance with certain embodiments of the presently disclosed subject matter.

The inspection system 100 illustrated in FIG. 1 can be used for inspection of a mask during or after the mask fabrication process. As described above, the inspection referred to herein can be construed to cover any kind of operations related to defect detection, defect filtering, defect classification of various types, and/or metrology operations, such as, e.g., critical dimension (CD) measurements, with respect to the mask or parts thereof. According to certain embodiments of the presently disclosed subject matter, the inspection system 100 comprises a computer-based system 101 capable of automatically filtering defects detected on a mask. System 101 is thus also referred to as a mask defect filtering system, which is a sub-system of the inspection system 100.

System 100 comprises a mask inspection tool 120 operatively connected to system 101 and configured to scan a mask and capture one or more images thereof for inspection of the mask. The term “mask inspection tool” used herein should be expansively construed to cover any type of inspection tool that can be used in mask inspection related processes, including, by way of non-limiting example, scanning (in a single or in multiple scans), imaging, sampling, detecting, measuring, classifying, and/or other processes provided with regard to the mask or parts thereof.

Without limiting the scope of the disclosure in any way, it should also be noted that the mask inspection tool 120 can be implemented as inspection machines of various types, such as optical inspection tools, electron beam tools, and so on. In some cases, the mask inspection tool 120 can be a relatively low-resolution inspection tool (e.g., an optical inspection tool, a low-resolution Scanning Electron Microscope (SEM), etc.). In some cases, the mask inspection tool 120 can be a relatively high-resolution inspection tool (e.g., a high-resolution SEM, an Atomic Force Microscopy (AFM), a Transmission Electron Microscope (TEM), etc.). In some cases, the inspection tool can provide both low-resolution image data and high-resolution image data. In some embodiments, the mask inspection tool 120 has metrology capabilities and can be configured to perform metrology operations on the captured images. The resulting image data (low-resolution image data and/or high-resolution image data) can be transmitted—directly or via one or more intermediate systems—to system 101.

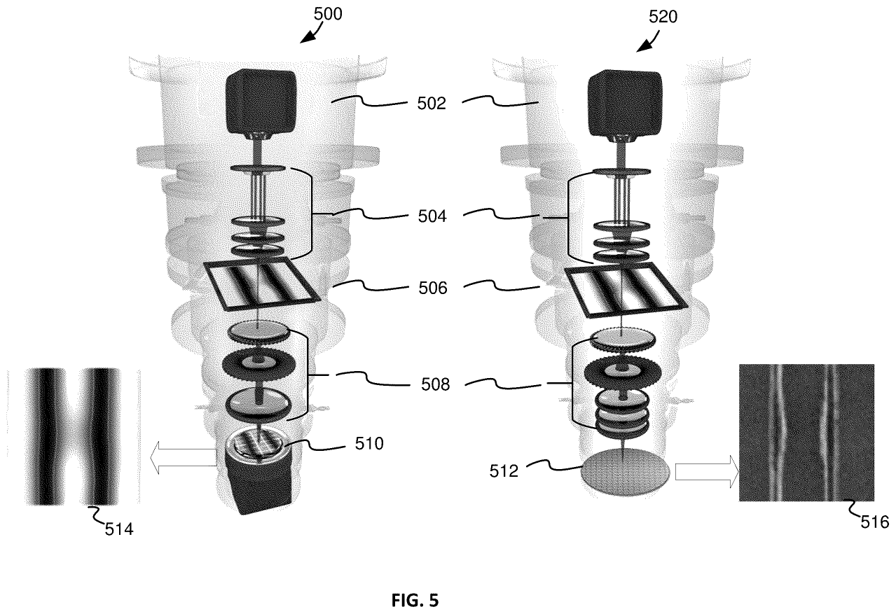

According to certain embodiments, in some cases, the mask inspection tool can be implemented as an actinic inspection tool configured to emulate/mimic optical configurations of a lithographic tool (such as, e.g., a scanner or a stepper) that is usable for fabrication of a semiconductor specimen, e.g., by projecting a pattern formed in a mask onto a wafer, as detailed below in FIG. 5.

Turning now to FIG. 5, there is shown a schematic illustration of an actinic inspection tool and a lithographic tool in accordance with certain embodiments of the presently disclosed subject matter.

Similar to a lithographic tool 520, an actinic inspection tool 500 may include an illumination source 502 configured to generate light (e.g., laser) at an exposure wavelength, illumination optics 504, mask holder 506, and projection optics 508. The illumination optics 504 and projection optics 508 may include one or more optical elements (such as, e.g., a lens, aperture, a spatial filter, etc.).

In a lithographic tool 520, a mask is positioned at the mask holder 506 and optically aligned to project an image of the circuit pattern to be duplicated onto a wafer placed on the wafer holder 512 (e.g., by employing various stepping, scanning, and/or imaging techniques to produce or replicate the pattern on the wafer). Unlike the lithographic tool 520, instead of placing a wafer holder 512, the actinic inspection tool 500 places a detector 510 (such as, e.g., charge-coupled device (CCD)) at the location of the wafer holder. The detector 510 is configured to detect the light that is projected through the mask, and generate an image of the mask.

As can be seen, the actinic inspection tool 500 is configured to emulate optical configurations of the lithographic tool 520, including but not limited to, e.g., illumination/exposure conditions such as wavelength, pupil shape, numerical aperture (NA), etc. Therefore, the mask image 514 acquired by the detector 510 is expected to resemble an image 516 of a wafer that is fabricated using the mask via the lithographic tool 520. A mask image acquired using such an actinic inspection tool is also referred to as an aerial image in the present disclosure. The aerial images of a mask are provided to system 101 for further processing, as described below.

According to certain embodiments, in some cases, the mask inspection tool 120 can be implemented as a non-actinic inspection tool, such as, e.g., a regular optical inspection tool, an electron beam tool, etc. In such cases, the non-actinic inspection tool can be configured to acquire an image of the mask. Simulation can be performed on the acquired image to simulate the optical configuration of the lithographic tool, thereby generating an aerial image. In some cases, the simulation can be performed by the system 101 (e.g., the functionality of the simulation can be integrated into the processing circuitry 102 thereof), while in some other cases, the simulation can be performed by a processing module of the mask inspection tool 120, or by a separate simulation unit which is operatively connected to the mask inspection tool 120 and system 101.

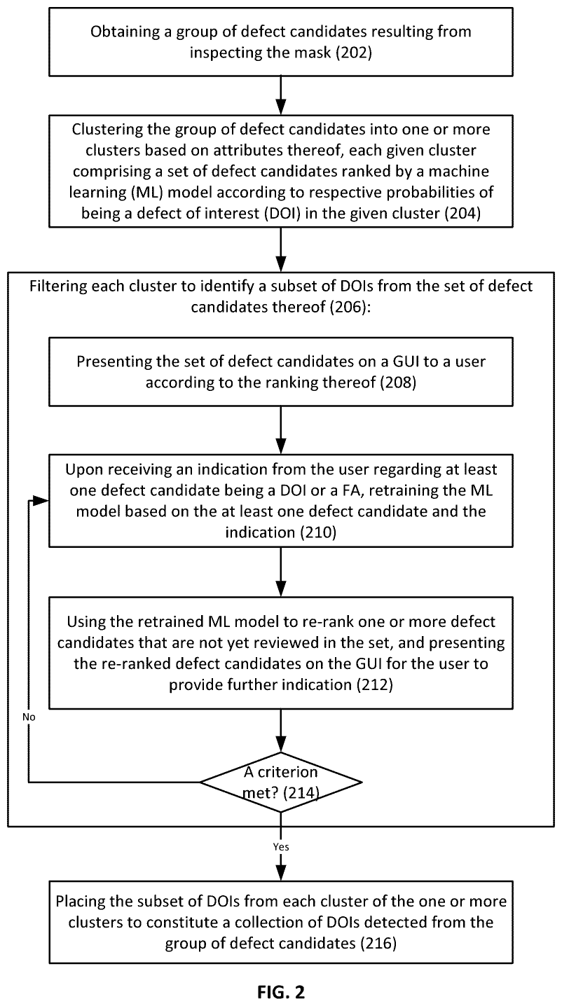

System 101 includes a processing circuitry 102 operatively connected to a hardware-based I/O interface 126 and configured to provide processing necessary for operating the system, as further detailed with reference to FIGS. 2-4. The processing circuitry 102 can comprise one or more processors (not shown separately) and one or more memories (not shown separately). The one or more processors of the processing circuitry can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, the functional modules comprised in processing circuitry 102 of system 101 can include a clustering module 104, a ranking module 106 and a filtering module 108 operatively connected to each other. The processing circuitry 102 can be configured to obtain, via I/O interface 126, a defect file comprising a group of defect candidates resulting from inspecting the mask. By way of example, the group of defect candidates can be detected using the mask inspection tool 120, such as, e.g., an actinic inspection tool.

The clustering module 104 can be configured, e.g., using a clustering model, to cluster the group of defect candidates into one or more clusters based on attributes thereof, each given cluster comprising a set of defect candidates. The ranking module 106 can be configured to rank, e.g., using a machine learning (ML) model (also referred to herein as a ranking model), the set of defect candidates according to their respective probabilities of being a defect of interest (DOI) in the given cluster. The ML model can be regarded as part of the ranking module 106. In some cases, the clustering and ranking can be performed by the same ML model (i.e., the clustering model and the ranking model are the same ML model). In some other cases, the clustering and the ranking can be performed by separate ML models (i.e., the clustering model and the ranking model are implemented as separate ML models).

The filtering module 108 can be configured to filter each cluster to identify a subset of DOIs from the set of defect candidates. Specifically, the filtering module 108 can be configured to present the set of defect candidates on a graphical user interface (GUI) 124 to a user according to the ranking thereof, and upon receiving an indication from the user regarding at least one defect candidate being a DOI or a false alarm (FA), retrain the ML model based on the at least one defect candidate and the indication. The retrained ML model can be used to re-rank one or more defect candidates that are not yet reviewed in the set of defect candidates. The filtering module 108 can present the re-ranked defect candidates on the GUI 124 for the user to provide further indication. The filtering module 108 can be configured to repeat the retraining, re-ranking, and presenting, until meeting a criterion.

The subset of DOIs, identified from each cluster of the one or more clusters, constitutes a collection of DOIs detected from the group of defect candidates.

According to certain embodiments, the ML model referred to herein, such as the clustering model or ranking model, can be implemented as various types of machine learning models. By way of example, the ML model can be implemented as one of the following: various decision trees, regression models, neural networks, and/or ensembles/combinations thereof. The learning algorithms used by the ML models can be any of the following: supervised learning, unsupervised learning, self-supervised, semi-supervised learning, or a combination thereof, etc. The presently disclosed subject matter is not limited to the specific types of the ML model or the specific types of learning algorithms used by the ML model.

By way of example, in some cases the ML model can be implemented as a deep neural network (DNN). DNN can comprise multiple layers organized in accordance with respective DNN architecture. By way of non-limiting example, the layers of DNN can be organized in accordance with architecture of a Convolutional Neural Network (CNN), Recurrent Neural Network, Recursive Neural Networks, autoencoder, Generative Adversarial Network (GAN), or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a DNN and the connections thereof can be initially selected prior to training, and can be further iteratively adjusted or modified during training to achieve an optimal set of weighting and/or threshold values in a trained DNN. After each iteration, a difference can be determined between the actual output produced by DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a DNN is referred to as a training set.

It is noted that the teachings of the presently disclosed subject matter are not bound by specific architecture of the ML models as described above.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as clustering, ranking, and filtering operations, etc., can thus be performed by respective processors (or processor combinations) in the processing circuitry 102, while, optionally, these operations may be performed by the same processor. The present disclosure should not be limited to being construed as one single processor always performing all the operations.

It is also to be noted that, in some cases, the functionalities of the processing circuitry 102 can be integrated, at least partially, as part of the inspection tool 120, while in some other cases, at least some of the functionalities can be implemented in a separate device, such as a server operatively connected to the inspection tool (either locally or remotely).

According to certain embodiments, system 100 can comprise a storage unit 122. The storage unit 122 can be configured to store any data necessary for operating systems 100 and 101, e.g., data related to input and output of systems 100 and 101, as well as intermediate processing results generated by system 101. By way of example, the storage unit 122 can be configured to store the defect file produced by the mask inspection tool 120 and/or derivatives thereof. Accordingly, the defect file can be retrieved from the storage unit 122 and provided to the processing circuitry 102 for further processing. The output of the system 101, such as, e.g., the collection of DOIs, etc., can be sent to storage unit 122 to be stored.

In some embodiments, system 100 can comprise a computer-based Graphical User Interface (GUI) 124 which is configured to enable user-specified inputs related to system 101. For instance, the user can be presented with a visual representation of the mask (for example, by a display forming part of GUI 124), such as images of the mask and/or defect distribution in the defect file. The defect candidates from each cluster can also be respectively presented on the GUI to the user according to their ranking. The user may be provided, through the GUI, with options of defining certain operation parameters, such as, e.g., an indication whether a defect candidate is a DOI or FA, etc. In some cases, the user may also view operation results, such as the subset of DOIs from each cluster, and/or the collection of DOIs filtered from the entire defect file, on the GUI.

In some embodiments, additionally to system 101, the mask inspection system 100 can further comprise one or more inspection modules, such as, e.g., additional defect detection module(s) and/or Automatic Defect Review Module (ADR) and/or Automatic Defect Classification Module (ADC) and/or metrology-related module and/or other inspection modules which are usable for performing additional inspection of a mask. The one or more inspection modules can be implemented as stand-alone computers, or their functionalities (or at least some thereof) can be integrated with the mask inspection tool 120. In some embodiments, the output as obtained from system 101 can be used by the mask inspection tool 120 and/or the one or more inspection modules (or part thereof) for further inspection of the mask.

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It is noted that the examination system illustrated in FIG. 1 can be implemented in a distributed computing environment, in which the aforementioned functional modules as comprised in the processing circuitry 102 can be distributed over several local and/or remote devices, and can be linked through a communication network. By way of example, the inspection tool 120 and the system 101 can be located at the same entity (in some cases hosted by the same device) or distributed over different entities. For instance, in some cases, the processing circuitry 102 can be hosted by the inspection tool 120, while in some other cases, the processing circuitry 102 can be implemented at a separate server (either locally or remotely) operatively connected to the tool.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It is further noted that in other embodiments at least some of the inspection tool 120, storage unit 122, and/or GUI 124 can be external to the examination system 100 and operate in data communication with system 101 via I/O interface 126. System 101 can be implemented as stand-alone computer(s) to be used in conjunction with the inspection tool. Alternatively, the respective functions of the system 101 can, at least partly, be integrated with the mask inspection tool 120, thereby facilitating and enhancing the functionalities of the mask inspection tool 120 in inspection-related processes.

While not necessarily so, the process of operation of systems 101 and 100 can correspond to some or all of the stages of the methods described with respect to FIGS. 2-4. Likewise, the methods described with respect to FIGS. 2-4 and their possible implementations can be implemented by systems 101 and 100. It is therefore to be noted that embodiments discussed in relation to the methods described with respect to FIGS. 2-4 can also be implemented, mutatis mutandis as various embodiments of the systems 101 and 100, and vice versa.

Referring now to FIG. 2, there is illustrated a generalized flowchart of defect filtering for mask inspection in accordance with certain embodiments of the presently disclosed subject matter.

A group of defect candidates resulting from inspecting a mask can be obtained (202) (e.g., by the processing circuitry 102 via I/O interface 126, from the mask inspection tool 120 or from the storage unit 122). By way of example, the group of defect candidates can be comprised in a defect file, as the output of a preliminary mask inspection process prior to the present defect filtering process. In some cases, the inspection images of the defect candidates, such as the aerial images as described above, can be obtained from the mask inspection process and saved together with the defect file for further processing.

Specifically, the mask is typically inspected by a mask inspection tool step by step, each time capturing an image of a respective portion of the mask. A plurality of inspection images of the mask can be sequentially obtained during the inspection. A plurality of defect maps can be generated (e.g., by a defect detection module of the mask inspection tool) corresponding to the plurality of inspection images. Each defect map can indicate defect candidate distribution on a respective inspection image. At the end of the entire inspection process, the plurality of defect maps can be combined to obtain an overall defect map for the entire mask, indicative of the spatial distribution of defect candidates across the mask. The defect map may typically resemble the layout of the mask itself and marks where defect candidates are located.

A defect on a mask can refer to any kind of abnormality or undesirable feature/functionality formed on the mask with respect to the original design. Defects on a mask can include various types of defects such as, e.g., bridges, protrusions, line breaks, defects related to critical dimension (CD), abnormality of contacts (such as missing contacts, merged contacts, shrunk contacts, etc.), or any other types of defects. By way of example, one type of defects may relate to edge positioning displacement (EPD) indicative of a deviation between the actual position of an edge/contour of a printable feature on the mask and the intended/expected position thereof. The present disclosure is not limited to any specific types of defects.

In some cases, a defect may be a defect of interest (DOI) which is a real defect that, when printed on the wafer, has certain effects on the functionality of the fabricated device, thus is in the customer's interest to be detected. In some other cases, a defect may be a nuisance (also referred to as “false alarm” defect) which can be disregarded because it has no effect on the functionality of the completed device.

A defect candidate refers to a suspected/potential defect on the mask which is detected to have relatively high probability of being a DOI. Therefore, a defect candidate, upon being reviewed, may actually be a DOI, or, in some other cases, it may be a nuisance or random noise that can be caused by different variations (e.g., process variation, color variation, mechanical and electrical variations, etc.) during inspection.

According to certain embodiments, the defect file resulting from the mask inspection can be represented in various data representations and formats. By way of example, in some cases, the defect file can be represented in the form of a defect map as described above. In some embodiments, the defect map can be further informative of one or more defect attributes characterizing the defect candidates. The attributes of the defect candidates can include various defect characteristics collected during the mask inspection process as mentioned above.

By way of example, the attributes can comprise, for each given defect candidate, a background pattern of the given defect candidate, i.e., the structural pattern/feature which the defect candidate is associated with, or resides on.

A structural feature can refer to any original object/element on the mask that has a geometrical shape/structure with a contour. In some cases, one object may be combined with other object(s), therefore forming a complex structural pattern. Examples of structural features can include general-shape features, such as, e.g., contacts, lines, etc., and/or features combined with one or more other features forming complex patterns. The background pattern herein can refer to any structural feature irrespective of its specific shape/complexity.

In some cases, the attributes can further include one or more of the following attributes of the given defect candidate: defect location on the mask (e.g., in terms of x, y coordinates in a mask coordinate system), defect density in a surrounding area (e.g., the ratio between the amount of defect candidates in a given area surrounding the given defect candidate with respect to the size of the given area), defect shape/pattern, size, gray level intensity (e.g., as reflected in the acquired mask image), the number of similar instances in the group of defect candidates, a defectivity grade/score, EPD, presence of a blemish pixel, and any other defect characteristics of the defect candidates revealed during the mask inspection.

By way of example, the number of similar instances, as a unique attribute of a given defect candidate, refers to the number of defect candidates in the entire group of defect candidates that are similar to the given defect candidate (e.g., similar in terms of defect shape/pattern). In other words, this attribute represents the occurrences of defect candidates with a similar pattern during the inspection of the entire mask. Such statistics are only available at the end of mask inspection, after the entire mask is inspected and detection results of different mask portions are consolidated.

As known, mask defects are very rare and tend to be non-repetitive. The number of total occurrences of similar instances of a given defect candidate can indicate the level of sparsity of such candidate, which indicates the likelihood of the defect candidate being a DOI (e.g., in cases where the occurrence is relatively low with respect to a threshold) or a false alarm.

For instance, if a defect candidate only appears once during the entire mask inspection (i.e., there are no other similar instances), it may indicate a relatively higher likelihood of such defect candidate being a DOI, as compared to a defect candidate which has, say, five similar instances in the group of defect candidates. The latter case may indicate these instances represent a unique but rather sparse design pattern in the mask, rather than a real defect. By way of example, there may be one structural feature with a unique shape of contour in an image which does not have a reference contour that has a similar shape thereto. In such cases, the inspection process may find no reference for this structural feature, thus reporting it as a defect candidate. In some cases, another instance of such a unique structural element may appear in some of the subsequent images acquired for other mask portions. At the end of the mask inspection process, all the detection information and statistics at image level can be centrally shared and consolidated. For example, after consolidating all image-level detection results, the number of total occurrences of similar instances of a given defect candidate may indicate it is a unique structural feature, rather than a true defect.

By way of another example, a defectivity grade/score, as a possible attribute of a given defect candidate, can be calculated in various manners, depending on a defect detection algorithm used during the mask inspection process. For instance, one way of calculating a defectivity score can be applying a normalization factor to the gray level intensity of the defect candidate as reflected in the acquired mask image (or derivatives thereof, such as, e.g., a difference image, or a grade image, resulting from comparison between the mask image and a reference image).

By way of yet another example, a blemish pixel, as a possible attribute of a given defect candidate, represents presence of a burned pixel in the acquired image. When stacking the plurality of inspection images acquired for different portions of the mask together, a specific pixel (at a specific location), with repetitive defect candidate presence, indicates the presence of a blemish pixel. The presence of such a pixel is typically caused by a physical phenomenon of the camera in the inspection tool.

It is to be noted that the above attributes are listed for exemplary and illustrative purposes only, and should not be regarded as limiting the present disclosure in any way. Any other defect attributes, collected during the mask inspection process, can be used in addition to or in lieu of the above. For instance, in some cases, additional attributes can be also collected, including, e.g., image acquisition information, such as acquisition time, acquisition tool ID, region ID, wafer ID, etc.

It is also to be noted that although the defect file is described above in the format of a defect map, this is for exemplary purposes only, and should not be regarded as limiting the present disclosure. In some cases, the defect file and the group of defect candidates thereof can be represented in different data representations other than defect maps. By way of example, the defect file can be represented as a tabular dataset, where the defect candidates and their attributes are stored in a table or table-like format. For instance, the tabular dataset can comprise a group of N defect candidates stored in a table, where each row represents a specific defect candidate (identified by its defect ID) in the group of defect candidates, and each column represents an attribute of the defect candidate. Similarly, any other suitable representation of such a defect file can be used in lieu of the formats mentioned above. For instance, any of the following data structures may be used instead of the defect map or tabular format, when appropriate: lists, graphs, or matrices, etc.

Continuing with the description of FIG. 2, the group of defect candidates can be clustered (204) (e.g., by the clustering module 104 in processing circuitry 102), into one or more clusters based on the attributes thereof. Each given cluster comprises a set of defect candidates ranked (e.g., by a ML model in the ranking module 106) according to their respective probabilities of being a defect of interest (DOI) in the given cluster. In some cases, the clustering and the ranking can be performed in two stages.

In some embodiments, the clustering module 104 can comprise a ML-based clustering model configured to find sets of defect candidates that are similar to each other in terms of their attributes. By way of example, the group of defect candidates represented in the attribute space can be clustered, using the ML-based clustering model, into one or more clusters based on their attribute values, such that the distance between any given candidate and another candidate in the same cluster is smaller than the distance between the given candidate and a third candidate assigned to another cluster. The clustering module can determine separation planes which are used to form the boundaries between the clusters within the attribute space.

The clustering model can utilize a variety of algorithms to perform clustering of defect candidates based on their attributes. The clustering can be performed using supervised or unsupervised learning. By way of example, certain unsupervised clustering algorithms that may be used can include: K-Means clustering, hierarchical clustering, Density-Based Spatial Clustering, Gaussian Mixture Models (GMM), gray-level correlation based clustering, or agglomerative clustering. Alternatively, some supervised clustering algorithms that may be used can include: Support Vector Machines (SVM), or Random Forest Clustering, etc. In some cases, the clustering can be performed in an ad hoc manner.

The ranking model is used to prioritize defect candidates within each cluster based on their likelihood of being a defect of interest (DOI). The model utilizes machine learning techniques to analyze various defect attributes and assign probabilities to each defect candidate within a cluster.

According to certain embodiments, in the ranking stage, it is possible to employ several ranking methods/models to perform “Consensus ranking”. “Consensus ranking” refers to a methodology where multiple ranking or prioritization criteria are integrated to reach a collective or agreed-upon order. In the present context, consensus ranking may involve combining different ranking algorithms to achieve a more reliable and robust ranking of defect candidates within each cluster. This approach can help mitigate biases or limitations inherent in individual ranking methods by leveraging diverse perspectives, thereby improving the overall accuracy and effectiveness of the ranking process.

By way of example, centroid and distance ranking can be performed based on the clusters identified the clustering stage. In centroid ranking, the centroid for each cluster can be calculated. Candidates within each cluster are ranked, based on their distance from the centroid. This method prioritizes candidates that are closer to the centroid, indicating higher relevance within the cluster. In distance ranking, pairwise distances between candidates within each cluster can be computed. Candidates that are closer to each other are ranked lower, reflecting their higher similarity or reduced relevance within the cluster.

By way of another example, a ranking algorithm based on density-based ranking techniques can be performed, such as, e.g., Density-Based Spatial Clustering of Applications with Noise (DBSCAN), or Ordering Points To Identify the Clustering Structure (OPTICS). This method can be based on a new feature space extracted specifically for the ranking stage, utilizing properties derived from the difference images of the defect candidates (e.g., difference images between the inspection images of defect candidates and the corresponding reference images thereof). In some cases, this new feature space can incorporate artificial features generated by, e.g., an Autoencoder or neural network, capturing complex patterns and characteristics from the defect images, and manual features, such as, e.g., the Signal-to-Noise Ratio (SNR) in the difference image, density, blob size, polarity, and sparsity etc.

Integrating the centroid and distance ranking, and the density-based ranking within a consensus framework, can enhance the precision and efficiency of defect identification and prioritization during mask inspection. This consensus-based approach may facilitate optimal manufacturing quality and yield by leveraging diverse ranking perspectives to address the variability and complexity of semiconductor defect patterns.

Having said the above, in some cases, each of the above ranking algorithms can be used independently for performing the ranking of the set of defect candidates within each cluster.

The ranking stage can utilize one or more ranking models which can be initially trained during a training phase. The ranking model(s) can learn from a training set of labeled data (e.g., where each defect candidate is associated with a binary label indicating whether it is a defect of interest (DOI) or not). The ranking model(s) learns to predict the probability of each defect candidate being a DOI within its respective cluster.

By way of example, in some cases, a ranking model can be trained to learn a sorting rule pertaining to a series of attributes. The sorting rule can be learnt in order to rank the set of defect candidates in a given cluster into a total order. In some cases, the series of attributes may be an optimal subset of attributes that is selected from all attributes characterizing the defect candidates, such that sorting all defect candidates according to the subset of attributes will result in a total order of candidates according to the sorting rule (e.g., ranking according to the probability to be a DOI).

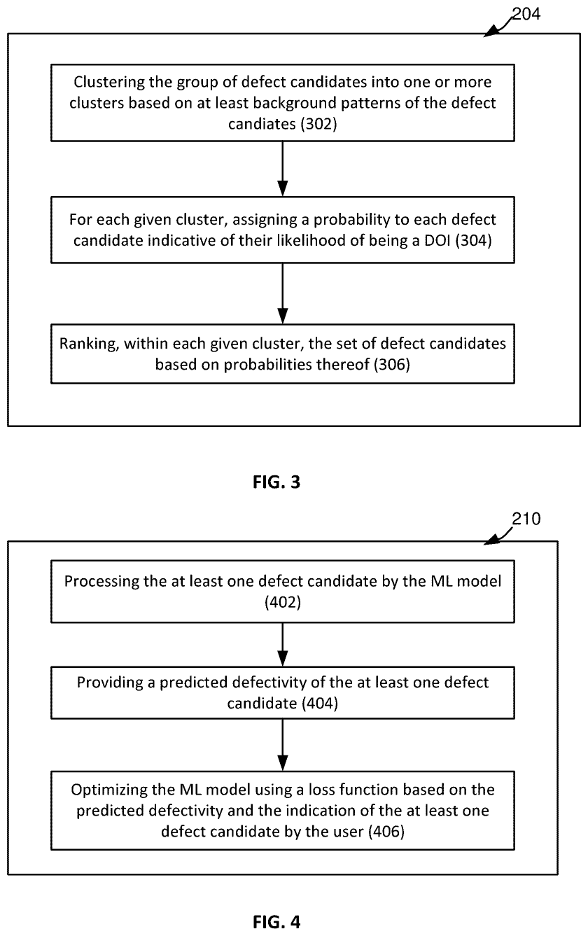

FIG. 3 illustrates a generalized flowchart of clustering the group of defect candidates into one or more clusters, and ranking within each cluster in accordance with certain embodiments of the presently disclosed subject matter.

In particular, in some embodiments, the attributes used for clustering should include at least the background pattern associated with each given defect candidate. This can ensure that defect candidates are grouped/clustered based on the specific structural context in which they occur. Clustering based on background patterns also allows for the identification of defects/FAs that are inherently linked to certain patterns. In some cases, true defects can vary widely in type and appearance, whereas FAs may share a common root cause related to the same background patterns. In such cases, by clustering based on background patterns, it becomes easier to identify and isolate those FAs that share a common root cause related to the same patterns. This can significantly reduce the number of false alarms and enable the inspection system to better handle the variability between the true defects, thus ensuring that DOIs are correctly identified, regardless of their specific types, and improving the overall accuracy and efficiency of the inspection process.

In such cases, the group of defect candidates, as comprised in the defect file, can be clustered (302) based on at least the background pattern associated with each given defect candidate. For purpose of implementing the clustering with an emphasis on background patterns, the background pattern should be accurately represented in the attribute space. By way of example, this may involve encoding the structural features of the background pattern into numerical or categorical attributes that can be used in the clustering algorithm. The ML model can be adapted to give appropriate weight to the background pattern attribute. This may involve, for instance, customizing the distance metrics or similarity measures used in the loss function to prioritize the background pattern.

Once the defect candidates are clustered, for each given cluster, a ranking model can be used to assign (304) a probability to each defect candidate indicative of their likelihood of being a DOI. The set of defect candidates within each given cluster can be ranked (306) based on the probabilities thereof, as described above. The ranking can be performed using any of the above-described models/algorithms.

Referring back to FIG. 2, once the clustering and ranking for the one or more clusters are completed, each cluster can be filtered (206) (e.g., by the filtering module 108) to identify a subset of DOIs from the set of defect candidates thereof.

Specifically, the set of defect candidates can be presented (208) on a GUI (e.g., the GUI 124) to a user according to the ranking thereof. By way of example, the image(s) of the set of defect candidates that are obtained during the preliminary mask inspection process can be presented on the GUI. The images of the defect candidates are acquired during the mask inspection process. In some embodiments, the images are aerial images acquired by an actinic mask inspection tool, such as, e.g., the Aera Mask Inspection tool of Applied Materials Inc. As described above with reference to FIG. 5, the actinic mask inspection tool is specifically configured to emulate the optical configurations of a lithographic tool (e.g., a scanner or a stepper) used for fabrication of the semiconductor wafers in accordance with the mask. The aerial images acquired by such an actinic inspection tool are expected to resemble an image of a wafer that is fabricated using the mask via the lithographic tool. In other words, the actinic mask inspection tool is configured so as to capture a mask image which can mimic how the design patterns in the mask would actually appear in a physical wafer after the fabrication process.

In some cases, the set of defect candidates in a given cluster can be presented to the user in one or more batches. The total number of batches to be presented is adapted to the GUI. For instance, the number of batches can be determined based on the total number of defect candidates in the set, the size of an image of each defect candidate, and the size of a display window on the GUI (i.e., the maximum number of defects that can be displayed on the display window at once). In particular, defect candidates with higher ranking are presented to the user first for prioritized review (e.g., the defect candidates with highest ranking are presented in the first batch(es)), such that defect candidates with a high likelihood of being DOIs will not be missed.

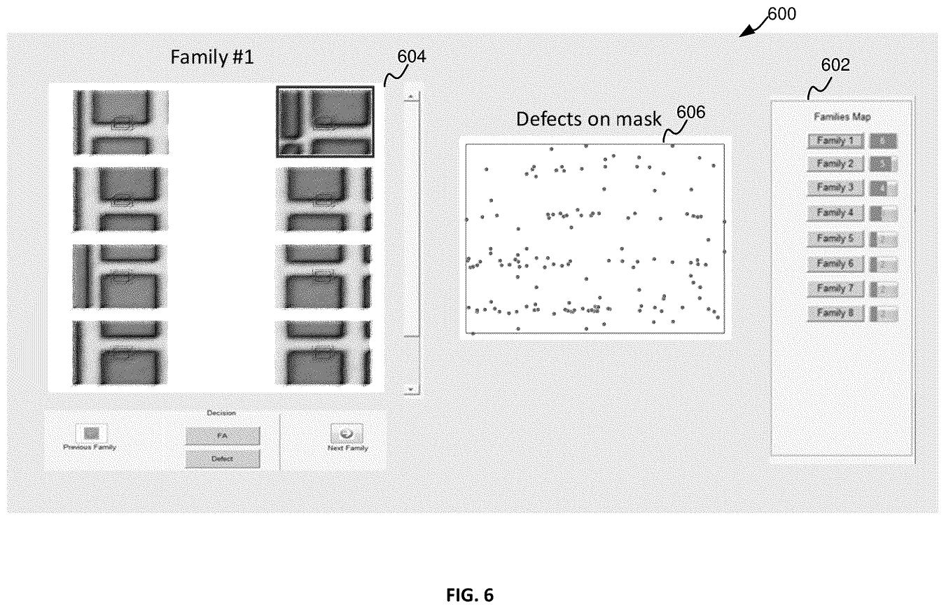

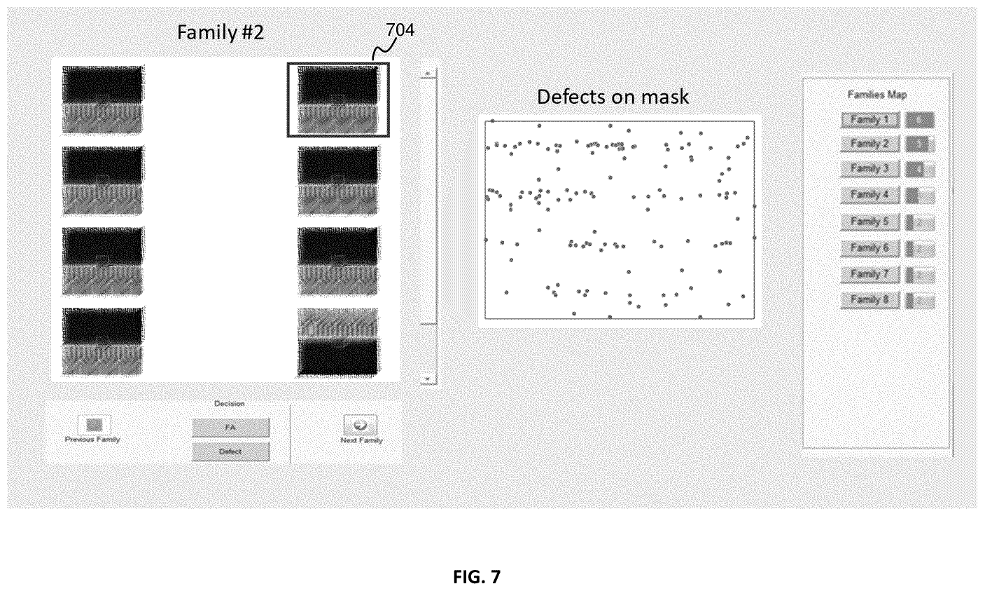

The user can review a batch of defect candidates that is currently presented on the GUI, and provide the indication by selecting at least one defect candidate from the batch and marking it as a DOI or a FA on the GUI. By way of example, the GUI can provide two decision buttons (or in alternative GUI representations, such as, e.g., checkboxes, etc.) respectively indicating “Defect” or “FA”, and the user can select a defect candidate from the presented batch (e.g., by clicking on the image of the defect candidate), and then clicking on the button of “Defect” to indicate it as a DOI. Once the user finishes reviewing the present batch, he/she can proceed to the next batch (e.g., by dragging a sliding bar, or clicking on a button of “Next batch” on the GUI) to continue his/her review of the subsequent batches of defect candidates, as will be detailed in the examples illustrated in FIGS. 6 and 7.

Upon receiving an indication from the user regarding at least one defect candidate being a DOI or a FA, the ML model can be retrained (210) based on the at least one defect candidate and the indication. FIG. 4 illustrates a generalized flowchart of retraining the ML model in accordance with certain embodiments of the presently disclosed subject matter.

The retraining of the ML model can be regarded as being performed by a training module (not illustrated in FIG. 1) comprised in system 101. Specifically, the at least one defect candidate can be processed (402) by the ML model. By way of example, the image(s) of the at least one defect candidate acquired from the preliminary mask inspection process can be fed as input to the ML model. The ML model can provide (404) a predicted defectivity of the at least one defect candidate as output. The training module can be configured to optimize (406) the ML model using a loss function based on the predicted defectivity and the indication of the at least one defect candidate received from the user.

In such cases, the indication from the user is used as ground truth label for the at least one defect candidate. The ML model is thus retrained in a supervised manner. The predicted defectivity can be evaluated with respect to the ground truth label of the at least one defect candidate (i.e., the indication from the user), using a loss function (e.g., a classification/filtration loss, such as, e.g., Cross Entropy, or Squared Hinge, etc.). The parameters of the ML model can be optimized to reduce/minimize the difference between the predicted defectivity and the ground truth label.

Once being re-trained, the retrained ML model can be used (212) (e.g., by the filtering module 108) to re-rank one or more defect candidates (in the set of defect candidates of the given cluster) that are not yet reviewed. The re-ranked defect candidates can be presented on the GUI according to the new ranking thereof, for the user to provide further indication.

By way of example, assume that the set of defect candidates in a given cluster has 20 defect candidates. A user, upon reviewing a first batch of 10 defect candidates on the GUI, selects two defect candidates and marks them as DOIs. The user's indication (i.e., marking the two candidates as DOIs) serves as ground truth labels of the two selected defect candidates. In response to receiving this indication, the two defect candidates and the labels thereof are used as training data to immediately re-train the ML model. The re-trained ML model is then used instantly to re-rank the rest of the defect candidates that are not yet reviewed by the user, i.e., the remaining 10 defect candidates in the set. The remaining defect candidates, upon being re-ranked, will be presented to the user in the next batch according to their new rankings. Namely, the defect candidate re-ranked with the highest probability of being a DOI is presented first, followed by other candidates with decreasing probabilities.

The re-training of the ML model, re-ranking of the un-reviewed defect candidates, and the presenting described above with reference to blocks 210 and 212, are performed on-the-fly in response to the user's indication. These operations can be repeated until a criterion is met (214). By way of example, the criterion can be predetermined, and can comprise at least one of the following: a confirmation from the user that no more DOIs are present in a given cluster (the confirmation can be provided by, e.g., the user clicking the button of “Next cluster”), no indication of DOIs in a number of consecutive batches of a given cluster, the set of defect candidates of a given cluster have all been reviewed by the user, or any other condition that may be used alone or in combination with the above to determine the completion of reviewing a given cluster.

If the criterion is not met, the process reverts to block 210, and the operations with reference to blocks 210 and 212 are repeated, with respect to the remaining defect candidates in the present cluster. Once it is verified that the criterion is met, the present cluster is determined as having been reviewed.

The iterative filtering process as described above with reference to block 206 can be performed for each cluster of the one or more clusters, to identify a respective subset of DOIs therefrom. The subset of DOIs from each cluster of the one or more clusters, when being placed (216) together, constitute a collection of DOIs detected from the group of defect candidates in the defect file. The collection of DOIs identified as such can meet a given defect review budget while maximizing detection capture rate (e.g., ensuring that no true defects are missed). In other words, the collection of DOIs is expected to capture all existing DOIs in the group of defect candidates (e.g., maintaining 100% capture rate).

Indeed, as described above, since the number of defect candidates in a defect file can reach several hundreds, it is impractical and costly for operators to manually review every defect candidate, making it necessary to prioritize which defects are reviewed. In order to filter the large volume of defect candidates to a smaller number for detailed review, without compromising the capture rate of true defects (in mask inspection, the goal is typically 100% capture rate), the present disclosure proposes a unique two-phase post-filtering process, where the group of defect candidates from the defect file are firstly clustered based on their attributes, such as, e.g., the background patterns thereof, which can assist in identifying FAs that share a common root cause related to the same background patterns, and, within each cluster, the defect candidates are initially ranked according to their probabilities of being Defects of Interest (DOIs).

In the second phase, i.e., the filtering within each cluster, the defect candidates in each cluster are presented on a GUI according to their rankings, and upon the user marking specific candidates as true DOIs or false alarms, the ML model is instantly retrained using these labeled defect candidates in real time. This re-trained model then re-ranks the remaining defect candidates in the cluster that have not yet been reviewed. The updated ranking is presented to the user, who can then continue the review process. This iterative filtering process ensures that the most likely true defects within each cluster are prioritized for review, continuously refining the model's accuracy with each iteration.

The filtering process as proposed above utilizes active learning based on user's instant feedback to retrain the model and re-rank the defect candidates on-the-fly. Active learning is a type of machine learning where unlabeled data is abundant, but manual or other trustable labeling is scarce or costly to obtain. The algorithm is designed to interactively (and iteratively) query the user or some other information source to obtain new labels to learn from. Unlike traditional machine learning, where the model is trained on a fixed dataset, active learning allows the model to continuously learn based on instantly updated datasets with labels. The goal of active learning is often to achieve higher accuracy with fewer labeled instances, by focusing on the most relevant data.

During this active learning process, determining how to prioritize/select the samples to query the user for new labels may be not trivial. By way of example, random selection from the set of defect candidates is likely to lead to over-representation of defects from dense areas (“dense” in terms of defect distribution in the defect map), and under-representation or no representation of sparse areas. The present disclosure proposes to present the defect candidates to the user according to their rankings (e.g., higher rankings first), in one or more batches, enabling the user to start the review from the most likely true defects, where it is more probable for him/her to identify DOIs. This instant feedback from the user is immediately used to re-train the model, which refines and re-enforces the model to provide updated rankings with higher accuracy for the non-reviewed candidates. The GUI will be refreshed where the remaining candidates are re-arranged and presented according to their new rankings, facilitating the user's subsequent review.

The iterative re-training of the machine learning model ensures that it becomes progressively better at distinguishing true defects from false alarms. The ability to re-train the model and update rankings in real-time allows for dynamic adaptation, based on the latest user feedback. This real-time learning ensures that the model remains current with the most recent data, enhancing its predictive capabilities. This continuous improvement helps in maintaining a high detection capture rate, ensuring that true defects are not missed.

By prioritizing defect candidates that are most likely to be true defects, it helps in optimizing the allocation of resources. Operators can focus their efforts on the most critical areas, thereby improving overall productivity and effectiveness. This learning process significantly reduces the total number of defect candidates that need to be manually reviewed by operators. By focusing the review on the most informative and likely true defects, the process becomes more efficient, saving time and labor costs.

Referring now to FIG. 6, there is illustrated an exemplary GUI presenting defect candidates from a given cluster in accordance with certain embodiments of the presently disclosed subject matter.

As shown on GUI 600, a family map 602 (the terms “cluster” and “family” are used interchangeably in the present disclosure) illustrates that eight clusters are obtained during the clustering process (204) performed by the ML model. The filtering process starts with family #1. A first batch of defect candidates from family #1 is presented in a display window 604 on the GUI. As illustrated, the defect candidates in family #1 share a similar background pattern, e.g., a sparse pattern with squared structures. The terms “sparse pattern” and “dense pattern” refer to the density of structural patterns within a particular region of the semiconductor specimen. A sparse pattern refers to a region of the specimen where the structural patterns are relatively widely spaced apart. The distribution of the defect candidates of family #1 on the whole mask is illustrated in the defect map 606.

Assume family #1 has n defect candidates, which will be presented to the user in one or more batches, based on the size of the display window. For instance, the exemplary display window 604 can present a batch of eight defect candidates every time. The user can drag the sliding bar on the side to switch between batches.

The first batch of defect candidates are currently illustrated to the user. The defect candidates are presented according to their probabilities of being DOIs, i.e., the one with the highest probability is presented first, followed by subsequent candidates with decreasing probabilities. Upon reviewing the presented eight candidates, the user selected the second candidate (e.g., the top right one), and marked it as DOI (e.g., by clicking on the button of “Defect” at the bottom of the GUI). The user then selected the last two candidates in this batch, and marked them as FAs (e.g., by clicking on the button of “FA”).

These indications of the selected defect candidates from the user are immediately used as new labels to re-train the ML model on-the-fly. Specifically, a training set comprising the three defect candidates with their respective labels (one with the label of DOI and the other two with the label of FA) is used to train the ML model in supervised learning. The re-trained ML model is instantly used to re-rank the remaining defect candidates (i.e., the n−8 candidates that are not yet reviewed by the user). Since the ML model is refined with the most updated information, it can provide updated rankings with higher accuracy of prediction for the non-reviewed candidates. The remaining candidates will be re-arranged on the GUI according to their new rankings by the re-trained model. When the user drags the sliding bar to proceed to the next batch, the candidates among the remaining ones that are re-ranked as having the highest probabilities are illustrated to him/her for further review.

Once the user finishes the review of family #1, e.g., after reviewing two batches of candidates, the user is confident that there is no more DOIs in the family, he/she can then click the button “Next family” to proceed to review family #2.

FIG. 7 illustrates the same GUI presenting defect candidates from another cluster (e.g., family #2) in accordance with certain embodiments of the presently disclosed subject matter.

The defect candidates from family #2 are similarly presented on the GUI 600. As shown in display window 704, the defect candidates in family #2 share a similar background pattern, e.g., a dense pattern (referring to a region of the specimen where the features or structures are closely packed together) of the edge of an array which is different from the background pattern of family #1. By clustering the defect candidates based on at least the background pattern, it can facilitate the user to identify false alarms that are caused by the same root cause related to a similar background pattern. The processing of family #2 is in a similar manner as of family #1, thus will not be repeated here for purpose of brevity.

In some embodiments, optionally, upon identifying the collection of DOIs, it can be determined how to respond to any DOIs, e.g., by evaluating their printability, or evaluating whether these defects, upon being printed, will affect the functionality of a semiconductor specimen manufactured using the mask. By way of example, the evaluation can include estimating variations of a printable structural element/feature that is associated with a defect when being printed on the semiconductor specimen. By way of example, the possible treatment operations in response to presence of defects can include: repairing the mask, defining the mask as a faulty mask, defining the mask as functional, generating a repair indication of the mask, and the like. For instance, if these estimated variations are not acceptable, then the mask can be sent to the mask shop to be repaired or rejected.

Additionally, in some embodiments, at least one of the following output/indications, or any combination thereof can be provided: (i) providing a qualification criteria for a mask to be shipped out of a mask shop; (ii) providing input to a mask generation process; (iii) providing input to a semiconductor specimen manufacturing process; (iv) providing input to a simulation model used in a lithographic process; (v) providing correction maps for a lithography tool; and (vi) identifying areas on the mask that are characterized by feature parameter variations which are larger than expected.

It is to be noted that the mask that is applicable to the presently disclosed inspection method can be any kind of mask, including but not limited to single-die masks and/or multi-die masks, memory masks and/or logic masks, and/or Arf masks and/or EUV masks, etc. The present disclosure is not limited to a specific type or functionality of the masks to be inspected.

According to certain embodiments, the defect filtration process as described above with reference to FIGS. 2, 3, and 4 can be included as part of an inspection recipe, such as, e.g., post-filtering of defect candidates, usable by system 101 and/or the inspection tool 120 for online mask inspection in runtime. Therefore, the presently disclosed subject matter also includes a system and method for generating an inspection recipe during a recipe setup phase, where the recipe comprises the steps as described with reference to FIGS. 2, 3, and 4 (and various embodiments thereof). It is to be noted that the term “inspection recipe” should be expansively construed to cover any recipe that can be used by an inspection tool for performing operations related to any kind of mask inspection including the embodiments as described above.

It is to be noted that examples illustrated in the present disclosure, such as, e.g., the mask inspection tool architectures and configurations, the exemplified clusters and background patterns, the specific design of the GUI, etc., are illustrated for exemplary purposes, and should not be regarded as limiting the present disclosure in any way. Other appropriate examples/implementations can be used in addition to, or in lieu of the above.

Among advantages of certain embodiments of the present disclosure as described herein is providing a two-phase post filtering process, where the first phase involves the clustering and initial ranking of defect candidates, and the second phase encompasses the iterative filtering process, including re-training and re-ranking of the machine learning model based on user feedback. The proposed process is capable of filtering a large volume of defect candidates to a smaller number meeting a review budget for detailed review, without compromising the capture rate of true defects (e.g., maintaining 100% capture rate for mask inspection).

It is to be appreciated that these two phases as described above should be regarded as an ordered combination that is inseparable, providing optimal detection outputs when used together. The first phase of clustering and ranking establishes a solid foundation for the second phase. Effective clustering, particularly when based on unique attributes such as the background pattern of defect candidates, significantly aids the user in identifying false alarms caused by common root causes associated with the same background pattern. This ordered combination ensures that the iterative filtering in the second phase operates on a well-organized set of defect candidates, thereby enhancing the accuracy and efficiency of the overall defect detection process. The synergy between these two phases ensures that the system can manage and prioritize defect candidates effectively, leading to improved detection and minimization of false positives. This integrated approach cannot be separated without compromising the performance and reliability of the invention, highlighting its technical advantages and the interdependence of its components.

The proposed process allows for providing a more sensitive recipe for post-filtering defect candidates detected on a photomask, capable of managing large volumes of defect candidates while ensuring no true defects are missed, ultimately improving the reliability and efficiency of photomask inspections.

Among further advantages of certain embodiments of the present disclosure as described herein is that by incorporating the background pattern of defect candidates as a critical attribute in the clustering process, the present disclosure leverages structural context to enhance defect identification, reduce false alarms, and optimize the overall inspection workflow, thereby improving the accuracy and efficiency of photomask inspection in semiconductor manufacturing.

Among further advantages of certain embodiments of the present disclosure as described herein is that by using active learning, the filtering process significantly reduces the total number of defect candidates that need to be manually reviewed by users. By focusing the review on the most informative and likely true defects, the process becomes more efficient, saving time and reducing risk of errors. Continuous re-training with user-provided ground truth data improves the model's ability to correctly identify true defects, maintaining a high detection capture rate. Real-time updates ensure the model adapts quickly to new information, improving its predictive performance with each iteration.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “filtering”, “inspecting”, “obtaining”, “clustering”, “ranking”, “presenting”, “receiving”, “retraining”, “using”, “repeating”, “meeting”, “constituting”, “enabling”, “training”, “providing”, “selecting”, “marking”, “processing”, “optimizing”, “reducing”, or the like, refer to the action(s) and/or process(es) of a computer that manipulate and/or transform data into other data, said data represented as physical, such as electronic, quantities and/or said data representing the physical objects.

The terms “computer” or “computer-based system” should be expansively construed to cover any kind of hardware-based electronic device with a data processing circuitry, including, by way of non-limiting example, the examination system, the recipe optimization system, and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a Graphics Processing Unit (GPU), a Tensor Processing Unit (TPU), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The term “mask” used in this specification is also referred to as “photolithographic mask”, or “photomask”, or “reticle”. Such terms should be construed equivalently and expansively to cover a template holding circuit design (e.g., defining the layout of a specific layer of an integrated circuit) to be patterned on a semiconductor wafer in a photolithography process. By way of example, a mask can be implemented as a fused silica plate covered with a pattern of opaque, transparent, and phase-shifting areas which are projected onto wafers in the lithography process. By way of example, a mask can be an Extreme Ultraviolet (EUV) mask or an Argon Fluoride (ArF) mask. By way of another example, a mask can be a memory mask (usable for fabricating a memory device) or a logic mask (usable for fabricating a logic device). By way of another example, a mask can be a single-die mask or a multi-die mask.

The term “inspection” or “mask inspection” used in this specification should be expansively construed to cover any operation for assessing the accuracy and integrity of a fabricated photomask with respect to the circuit design and its ability to produce an accurate representation of the circuit design onto the wafer. The inspection can include any kind of operations related to defect detection, defect review and/or defect classification of various types, and/or metrology operations during and/or after the mask fabrication process and/or during the usage of the mask for semiconductor specimen fabrication. Inspection can be provided by using non-destructive inspection tools after fabrication of the mask. By way of non-limiting example, the inspection process can include one or more of the following operations: scanning (in a single or in multiple scans), imaging, sampling, detecting, measuring, classifying and/or other operations provided with regard to the mask or parts thereof, using an inspection tool. Likewise, mask inspection can also be construed to include, for example, generating an inspection recipe(s) and/or other setup operations, prior to the actual inspection of the mask. It is noted that, unless specifically stated otherwise, the term “inspection” or its derivatives used in this specification are not limited with respect to resolution or size of an inspection area. A variety of non-destructive inspection tools includes, by way of non-limiting example, optical inspection tools, scanning electron microscopes, atomic force microscopes, etc.

The term “metrology operation” used in this specification should be expansively construed to cover any metrology operation procedure used to extract metrology information relating to one or more structural elements on a mask. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed for example, by employing image-processing techniques. Note that, unless specifically stated otherwise, the term “metrology” or derivatives thereof used in this specification are not limited with respect to measurement technology, measurement resolution, or size of inspection area.

The term “specimen” used in this specification should be expansively construed to cover any kind of wafers, related structures, combinations and/or parts thereof used for manufacturing semiconductor integrated circuits, magnetic heads, flat panel displays, and other semiconductor-fabricated articles.

The term “defect” used in this specification should be expansively construed to cover any kind of abnormality or undesirable feature formed on a mask. A defect in some cases can refer to a real defect or a defect of interest (DOI) which, when printed on the wafer, has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device and does not impact yield.

The term “defect candidate” used in this specification should be expansively construed to cover a suspected defect location on the mask which is detected to have relatively high probability of being a defect of interest (DOI). Therefore, a DOI candidate, upon being reviewed/tested, may actually be a DOI, or, in some other cases, it may be nuisances, or random noise that can be caused by different variations (e.g., process variation, color variation, mechanical and electrical variations, etc.) during inspection.

The term “image(s)” or “image data” used in the specification should be expansively construed to cover any original images/frames of the mask captured by a mask inspection tool, derivatives of the captured images/frames obtained by various pre-processing stages, and/or computer-generated synthetic images. It is to be noted that in some cases the image data referred to herein can include, in addition to images (e.g., captured images, processed images, etc.), numeric data associated with the images (e.g., metadata, hand-crafted attributes, etc.). It is further noted that the image data relates to a target layer of a semiconductor device to be printed on the wafer.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of defect filtering for a mask usable for manufacturing a semiconductor specimen, the system comprising a processing circuitry configured to:
obtain a group of defect candidates resulting from inspecting the mask;
cluster the group of defect candidates into one or more clusters based on attributes thereof, each given cluster comprising a set of defect candidates ranked by a machine learning (ML) model according to respective probabilities of being a defect of interest (DOI) in the given cluster; and
filter each cluster to identify a subset of DOIs from the set of defect candidates thereof, comprising:
presenting the set of defect candidates on a graphical user interface (GUI) to a user according to the ranking thereof;
upon receiving an indication from the user regarding at least one defect candidate being a DOI or a false alarm (FA), retraining the ML model based on the at least one defect candidate and the indication;
using the retrained ML model to re-rank one or more defect candidates that are not yet reviewed in the set, and presenting the re-ranked defect candidates on the GUI for the user to provide further indication; and
repeating the retraining, the using of the retrained ML model and the presenting of the re-ranked defect candidates, until meeting a criterion;
wherein the subset of DOIs from each cluster of the one or more clusters constitute a collection of DOIs detected from the group of defect candidates.

2. The computerized system according to claim 1, wherein the attributes of the defect candidates are collected during the inspection of the mask, the attributes comprising, for each defect candidate, a background pattern thereof.

3. The computerized system according to claim 2, wherein the clustering based on at least the background pattern of each defect candidate enables to identify, in each of the one or more clusters resulting from the clustering, FAs sharing a common root cause related to a similar background pattern.

4. The computerized system according to claim 2, wherein the attributes further comprise, for each defect candidate, one or more of: location on the mask, density in a surrounding area, shape, size, gray level intensity, the number of similar instances in the group of defect candidates, a defectivity grade, edge positioning displacement, and presence of a blemish pixel.

5. The computerized system according to claim 1, wherein the clustering further comprises, for each cluster, assigning a probability to each defect candidate indicative of respective likelihood of being a DOI, and ranking the set of defect candidates in the cluster based on assigned probabilities thereof.

6. The computerized system according to claim 1, wherein the set of defect candidates in a given cluster is presented to the user in one or more batches, where defect candidates with highest ranking are presented in a first batch for prioritized review so as not to miss defect candidates with high likelihood of being DOIs.

7. The computerized system according to claim 1, wherein the user provides the indication by selecting the at least one defect candidate from a batch of defect candidates that is currently presented on the GUI, and marking the selected at least one defect candidate as a DOI or a FA on the GUI.

8. The computerized system according to claim 1, wherein the retraining of the ML model comprises processing the at least one defect candidate by the ML model to obtain a predicted defectivity thereof, and optimizing the ML model using a loss function based on the predicted defectivity and the indication of the at least one defect candidate received from the user.

9. The computerized system according to claim 1, wherein the criterion comprises at least one of: a confirmation from the user that no more DOIs are present in a given cluster, no indication of DOIs in a number of consecutive batches of a given cluster, and the set of defect candidates of a given cluster all being reviewed.

10. The computerized system according to claim 1, wherein the filtering of each cluster reduces the total number of defect candidates to be reviewed by the user, while obtaining the collection of DOIs with maximized capture rate.

11. The computerized system according to claim 1, wherein the mask is an Extreme Ultraviolet (EUV) mask or an Argon Fluoride (ArF) mask.

12. A computerized method of defect filtering for a mask usable for manufacturing a semiconductor specimen, comprising:
obtaining a group of defect candidates resulting from inspecting the mask;
clustering the group of defect candidates into one or more clusters based on attributes thereof, each given cluster comprising a set of defect candidates ranked by a machine learning (ML) model according to respective probabilities of being a defect of interest (DOI) in the given cluster; and
filtering each cluster to identify a subset of DOIs from the set of defect candidates thereof, comprising:
presenting the set of defect candidates on a graphical user interface (GUI) to a user according to the ranking thereof;
upon receiving an indication from the user regarding at least one defect candidate being a DOI or a false alarm (FA), retraining the ML model based on the at least one defect candidate and the indication;
using the retrained ML model to re-rank one or more defect candidates that are not yet reviewed in the set, and presenting the re-ranked defect candidates on the GUI for the user to provide further indication; and
repeating the retraining, the using of the retrained ML model and the presenting of the re-ranked defect candidates, until meeting a criterion;
wherein the subset of DOIs from each cluster of the one or more clusters constitute a collection of DOIs detected from the group of defect candidates.

13. The computerized method according to claim 12, wherein the attributes of the defect candidates are collected during the inspection of the mask, the attributes comprising, for each defect candidate, a background pattern thereof.

14. The computerized method according to claim 13, wherein the clustering, based on at least the background pattern of each defect candidate, enables to identify, in each of the one or more clusters resulting from the clustering, FAs sharing a common root cause related to a similar background pattern.

15. The computerized method according to claim 13, wherein the attributes further comprise, for each defect candidate, one or more of: location on the mask, density in a surrounding area, shape, size, gray level intensity, the number of similar instances in the group of defect candidates, a defectivity grade, edge positioning displacement, and presence of a blemish pixel.

16. The computerized method according to claim 12, wherein the set of defect candidates in a given cluster is presented to the user in one or more batches, where defect candidates with highest ranking are presented in a first batch for prioritized review so as not to miss defect candidates with high likelihood of being DOIs.

17. The computerized method according to claim 12, wherein the user provides the indication by selecting the at least one defect candidate from a batch of defect candidates that is currently presented on the GUI, and marking the selected at least one defect candidate as a DOI or a FA on the GUI.

18. The computerized method according to claim 12, wherein the retraining of the ML model comprises processing the at least one defect candidate by the ML model to obtain a predicted defectivity thereof, and optimizing the ML model using a loss function based on the predicted defectivity and the indication of the at least one defect candidate received from the user.

19. The computerized method according to claim 12, wherein the filtering each cluster reduces the total number of defect candidates to be reviewed by the user, while obtaining the collection of DOIs with maximized capture rate.

20. A non-transitory computer readable storage medium tangibly embodying a program of instructions that, when executed by a computer, cause the computer to perform a method of defect filtering for a mask usable for manufacturing a semiconductor specimen, comprising:
obtaining a group of defect candidates resulting from inspecting the mask;
clustering the group of defect candidates into one or more clusters based on attributes thereof, each given cluster comprising a set of defect candidates ranked by a machine learning (ML) model according to respective probabilities of being a defect of interest (DOI) in the given cluster; and
filtering each cluster to identify a subset of DOIs from the set of defect candidates thereof, comprising:
presenting the set of defect candidates on a graphical user interface (GUI) to a user according to the ranking thereof;
upon receiving an indication from the user regarding at least one defect candidate being a DOI or a false alarm (FA), retraining the ML model based on the at least one defect candidate and the indication;
using the retrained ML model to re-rank one or more defect candidates that are not yet reviewed in the set, and presenting the re-ranked defect candidates on the GUI for the user to provide further indication; and
repeating the retraining, the using of the retrained ML model, and the presenting of the re-ranked defect candidates, until meeting a criterion;
wherein the subset of DOIs from each cluster of the one or more clusters constitute a collection of DOIs detected from the group of defect candidates.
